(19) United States
(12) Patent Application Publication
(10) Pub. No.: US 2025/0329165 A1
(43) Pub. Date: Oct. 23, 2025

(54) METHOD AND SYSTEM FOR MANAGING WATCHING SERVICE

(71) Applicant: TOYOTA JIDOSHA KABUSHIKI KAISHA, Toyota-shi Aichi-ken (JP)

(72) Inventors: Koki SONE, Taito-ku Tokyo-to (JP); Yuta MORI, Chuo-ku Tokyo-to (JP); Takahiro IWASAKI, Kiyose-shi Tokyo-to (JP); Bing XUE, Edogawa-ku Tokyo-to (JP)

(73) Assignee: TOYOTA JIDOSHA KABUSHIKI KAISHA, Toyota-shi Aichi-ken (JP)

(21) Appl. No.: 19/184,479

(22) Filed: Apr. 21, 2025

(30) Foreign Application Priority Data
Apr. 23, 2024 (JP) 2024-069945

(51) Int. Cl. G06V 20/52; G06V 10/74; G06V 40/16

(52) U.S. Cl. CPC G06V 20/52; G06V 10/761; G06V 40/172

(57) ABSTRACT

A system for managing a watching service that provides a user with a video including a watching target captured by using an infrastructure camera comprises a first infrastructure camera, a second infrastructure camera, and processing circuitry. The first and second infrastructure cameras are included in the infrastructure camera. The first infrastructure camera captures a face image of a person passing through a doorway of a building. The second infrastructure camera captures a full-body image of a person passing through the same doorway as the doorway captured by the first infrastructure camera. The processing circuitry performs watch processing of the watching target using first frames from the first infrastructure camera and second frames from the second infrastructure camera.

### CROSS-REFERENCE TO RELATED APPLICATIONS

The present application claims priority under 35 U.S.C. § 119 to Japanese Patent Application No. 2024-069945, filed on Apr. 23, 2024, the contents of which application are incorporated herein by reference in their entirety.

### TECHNICAL FIELD

The present disclosure relates to a method and a system for managing a service for providing a user with an image in which a watching target captured by using an infrastructure camera is shown.

### BACKGROUND

JP2022030846A discloses a person tracking system. This system periodically acquires surveillance images by a plurality of surveillance cameras, and detects at least one of a face image similar to a registered face image of a tracking target and a full body image similar to a registered full body image of the tracking target. When an image similar to at least one of the registered face image and the registered full body image of the tracking target is detected, the detected image is output.

References showing technical level of the art related to the present disclosure include JP2020178167A and JP2007329627A, in addition to JP2022030846A.

In a service for providing a user with a video in which a watching target captured by using an infrastructure camera is shown (hereinafter, also referred to as a “watching service”), a camera system including the infrastructure camera tracks the watching target. To perform this tracking, the camera system needs to have a full-body image of the watching target identified by a face authentication.

Here, it is considered that the clothes of the watching target change every day. In order to grasp the full-body image of the watching target, it is considered that a camera is installed in an entrance of his/her home separately from the infrastructure camera. In this case, when the watching target goes out every day, the full-body image of the watching target can be acquired. However, in this case, there is a possibility that the face image cannot be acquired by the camera for full-body image or the face authentication using the face image fails. Therefore, improvements are desired to reliably acquire a full-body image including the clothes of the watching target and a face image necessary for face authentication.

An object of the present disclosure is to provide a technique for enabling appropriate operation of the watching service by reliably acquiring the full-body image and the face image of the watching target necessary for daily tracking of the watching target.

### SUMMARY

A first aspect of the present disclosure is a system for managing a watching service that provides a user with an image including a watching target captured by an infrastructure camera and has the following features.

The system includes a first infrastructure camera, a second infrastructure camera, and processing circuitry. The first and second infrastructure cameras are included in the infrastructure camera. The first infrastructure camera captures a face image of a person passing through a doorway of a building. The second infrastructure camera captures a full-body image of a person passing through the doorway. The processing circuitry is configured to perform watch processing of the watching target using first frames from the first infrastructure camera and second frames from the second infrastructure camera.

A second aspect of the present disclosure is a method for managing a watching service that provides a user with an image including a watching target captured by an infrastructure camera and has the following features.

The method includes: acquiring first frames from a first camera included in the infrastructure camera and configured to capture a face image of a person passing through a doorway of a building; acquiring second frames from a second camera included in the infrastructure camera and configured to capture a full-body image of the person passing through the doorway; and performing watch processing of the watching target using the first and second frames.

According to the present disclosure, the face image of the person passing through the doorway of the building is captured by the first infrastructure camera. In addition, the full-body image of the person passing through the doorway of the building is acquired by the second infrastructure camera. Therefore, when the watching target passes through the doorway of the building, the full-body image and the face image of the watching target required for daily tracking of the watching target can be reliably obtained.

In addition, according to the present disclosure, the watch processing using the first and second infrastructure cameras from the first and second infrastructure cameras is performed. According to the watch processing using the first frames, for example, it is possible to identify the face image of the person that matches that of the watching target. Further, according to the watch processing using the second frames, for example, it is possible to identify the full-body image of the person whose face image matches that of the watching target. That is, according to the watch processing using the first and second frames, it is possible to identify the full-body image of the watching target. If the full-body image of the watching target can be identified, the watching target can be tracked based on the full-body image and the frames from the infrastructure cameras other than the first and second infrastructure cameras. Therefore, according to the present disclosure, the watching service can be appropriately operated.

### BRIEF DESCRIPTION OF THE DRAWINGS

FIG. 1 is a diagram illustrating an outline of a watching service;

FIG. 2 is a flowchart showing an example of information processing performed when frames including an image of a watching target are provided to a user terminal;

FIG. 3 is a diagram for explaining features of the watch processing of the watching target performed in the embodiment;

FIG. 4 is a diagram for explaining a first example in which the watch processing is shared by two or more data processing devices; and

FIG. 5 is a diagram for explaining a second example in which the watch processing is shared by two or more data processing devices.

### DESCRIPTION OF EMBODIMENT

Hereinafter, embodiments of the present disclosure will be described with reference to the drawings. In the drawings, the same or corresponding parts are denoted by the same reference numerals, and the description thereof will be simplified or omitted.

### 1. Watching Service

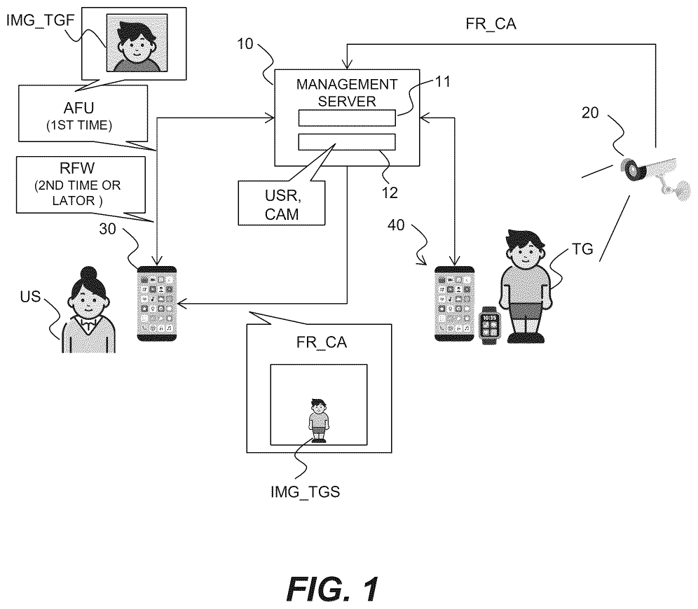

FIG. 1 is a diagram illustrating an outline of a watching service. The watching service is a service for specifying frames FR_CA including an image IMG_TG of a watching target TG from frames FR_CA acquired by a plurality of infrastructure cameras constituting the infrastructure cameras 20 (in the example shown in FIG. 1, a shape image (a full body image) IMG_TGS) and providing the specified frames FR_CA to a communication terminal (hereinafter, also referred to as a “user terminal”) 30 of the user US. Here, the user US is a person who uses the watching service. The watching target TG is a person that the user US wants to watch (for example, a family member of the user US, a friend of the user US, or a person cared by the user US).

FIG. 1 is also a diagram illustrating an example of an overall configuration of a system for managing the watching service according to the embodiment. In the example shown in FIG. 1, the management system includes a management server 10, infrastructure cameras 20, a user terminal 30, and a communication terminal (hereinafter, also referred to as a “target terminal”) 40 of a watching target TG. The infrastructure cameras 20, the user terminal 30, and the target terminal 40 communicate with the management server 10 via a communication network (not shown). The communication network is not particularly limited, and a wired or wireless network is used.

The management server 10 includes a data processing device 11 and a database 12. The data processing device 11 includes at least one processor and at least one memory. Examples of the processor include a general-purpose processor, a special-purpose processor, a central processing unit (CPU), a graphics processing unit (GPU), an application specific integrated circuit (ASIC), a field-programmable gate array (FPGA), an integrated circuit, and/or a combination thereof. The memory is a volatile memory such as a DDR memory, and develops various programs used in various processes performed by the processor and temporarily stores various data. The various data used by the processor includes data stored in the database 12.

The database 12 is formed in a predetermined memory device (for example, a hard disk or a flash memory). The database 12 stores user data USR and camera data CAM. The user data USR is transmitted from the user terminal 30 to the management server 10. The user data USR includes identification information of the user US, identification information of the watching target TG, and the like. The camera data CAM includes identification information of each of the plurality of infrastructure cameras constituting the infrastructure cameras 20, positional information of these infrastructure cameras, frames FR_CA acquired by these infrastructure cameras, and the like.

The infrastructure cameras 20 include a plurality of infrastructure cameras. These infrastructure cameras include not only an infrastructure camera installed outdoors but also an infrastructure camera installed indoors. A part or all of the imaging ranges of the two or more infrastructure cameras may overlap. Each infrastructure camera acquires frames FR_CA. The frames FR_CA is a set of images (frames) constituting a video (that is, a camera video) acquired by the infrastructure camera. Each infrastructure camera also transmits the obtained frames FR_CA to the management server 10 together with its own identification information.

The user terminal 30 is a terminal having a communication function, such as a smartphone, a tablet, or a notebook computer carried by the user US. The user terminal 30 is used when the user US uses the watching service for the first time. At the time of the first use, an application for use AFU (Application For Use) for the use of the watching service is transmitted from the user terminal 30 to the management server 10. The application for use AFU includes user data USR including identification information of the user US, identification information of the watching target TG, and the like. When the user data USR is registered in the database 12, the watching service can be used.

Examples of the identification information of the user US include attribute information (for example, name, gender, and age) of the user US and identification information of the user terminal 30. The identification information of the watching target TG is exemplified by face image IMG_TGF of the watching target TG and attribute information (for example, name, gender, age) of the watching target TG. The identification information of the watching target TG may include identification information of the target terminal 40 and relationship information between the user US and the watching target TG (for example, family, friends, and persons cared by the user US).

The user terminal 30 is also used when the user US uses the watching service for the second time or later. When the user terminal 30 is used for the second time or later, a request for watching RFW (Request For Watch) is transmitted from the user terminal 30 to the management server 10. The request for watching RFW includes, for example, login information of the user US for accessing the database 12. Information for updating a part or all of the data of the user data USR registered in the database 12 may be transmitted to the request for watching RFW. When such update information is included in the request for watching RFW, the user data USR registered in the database 12 is updated.

The target terminal 40 is a terminal with communication functions, such as smartphones and wearable devices carried by the watching target TG. The target terminal 40 also has a GPS (Global Positioning System) function. With the GPS function, the target terminal 40 transmits the positional information of the target terminal 40 to external equipment (e.g., the management server 10, the user terminal 30). The target terminal 40 is an arbitrary component of the management system according to the present disclosure. That is, the management system according to the present disclosure may be configured by the management server 10, the infrastructure cameras 20, and the user terminal 30.

### 2. Providing Camera Video

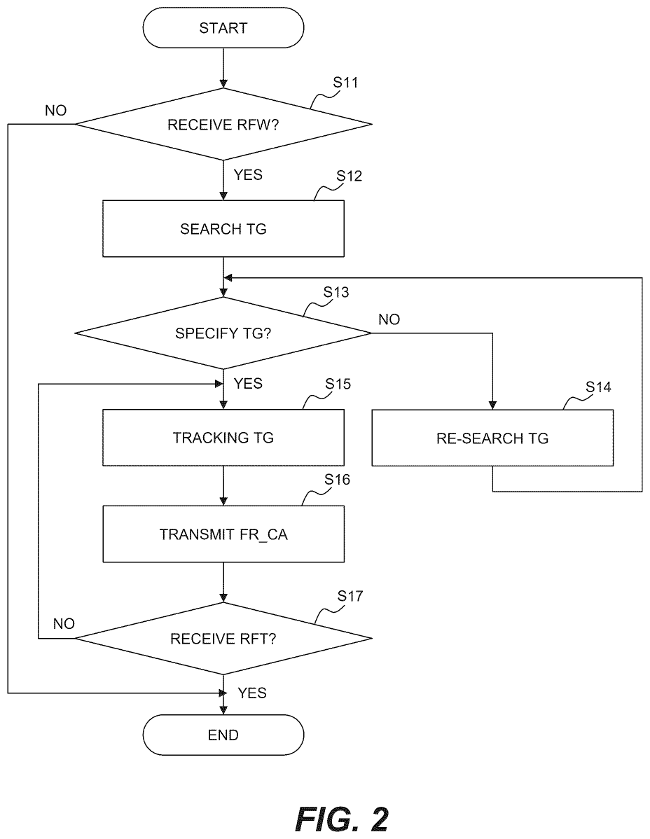

FIG. 2 is a flowchart showing an example of information processing performed when the frames FR_CA including the image IMG_TG are provided to the user terminal 30. The routine shown in FIG. 2 is repeatedly executed by the data processing device 11 shown in FIG. 1, for example.

In the routine shown in FIG. 2, first, as the processing of step S11, it is determined whether or not a request for watching RFW has been received. As described above, the request for watching RFW includes the login information of the user US for accessing the database 12. If the judgment result in step S11 is positive, the process in step S12 is performed.

In the processing of step S12, the watching target TG is searched using the frames FR_CA stored in the database 12. In this search, the database 12 is referred to using the login information received in the processing of step S11 as a key, and a feature quantity FTG of the watching target TG included in the user data USR corresponding to the login information is identified.

Here, the feature quantity FTG of the watching target TG may be extracted based on the shape image IMG_TGS of the watching target TG. The feature quantity FTG is used to search for the watching target TG. The feature quantity FTG is also used to re-identify the watching target TG. The feature quantity FTG is an example of the feature quantity FPS of the person PS. The feature quantity FPS is extracted by, for example, applying a bounding box group representing the same person in a plurality of time steps to a Re-ID model based on machine learning. Note that the extraction of the feature quantity FPS itself is a well-known technique, and the extraction method applied to the processing in step S15 is not particularly limited.

When the feature quantity FTG is specified, a full-body image having a feature quantity matching the feature quantity FTG is specified. Then, the frames FR_CA including the full-body image and the infrastructure camera that has acquired the frames FR_CA are specified. The frames FR_CA including the full-body image are specified by, for example, comparing the feature quantity FPS extracted from the frames FR_CA acquired by each infrastructure camera with the feature quantity FTG. For example, the frames FR_CA including the full-body image from which the feature quantity FPS having the similarity with the feature quantity FTG equal to or greater than the threshold is extracted is specified as the frames FR_CA including the full-body image having the feature quantity matching the feature quantity FTG. The identified frames FR_CA are frames including a frame closest to the current time t.

The processing of step S12 is performed for a predetermined time. When a predetermined time has elapsed from the start of the processing of step S12, the processing of step S13 is performed. In the processing of step S13, it is determined whether or not the watching target TG has been identified. That is, it is determined whether or not the frames FR_CA including the full-body image having the feature quantity matching the feature quantity FTG and the infrastructure camera that has acquired the frames FR_CA are specified. If the judgment result in step S13 is negative, the process in step S14 is performed.

In the processing of step S14, the watching target TG is searched again using the frames FR_CA stored in the database 12. The method of this re-search is basically the same as the method described in the processing of step S12. As in the processing of step S12, the processing of step S14 is performed for a predetermined time. However, while the search focusing on the frame at the current time t is performed in the processing of step S12, the search focusing on the frames at the current time t and the time t-k (k≥1) is performed in the processing of step S14.

If the judgment result in step S13 is positive, the processing in steps S15 and S16 is performed. In the processing of step S15, the tracking of the watching target TG is performed. The tracking is a technique for automatically tracking the same person included in frames based on a tracking algorithm. The tracking in one infrastructure camera is performed by, for example, estimating that person PS having the same feature quantity FPS extracted from frames FR_CA is the same person. The tracking in two or more infrastructure cameras is performed by, for example, comparing the feature quantity FPS between the infrastructure cameras and estimating that the person PS having the same feature quantity FPS between the infrastructure cameras is the same person.

The tracking of the watching target TG is performed by tracking a person that can be estimated to be the same person as the watching target TG using the feature quantity FTG. By tracking the watching target TG, the image IMG_TG (shape image IMG_TGS) of the watching target TG is specified. In the processing of step S16, the frames FR_CA including the image IMG_TG specified in this way are transmitted to the terminals (that is, the user terminals 30) that are the transmission sources of the request for watching RFW.

The processing of step S16 is followed by the processing of step S17. In the processing of step S17, it is determined whether or not a request for termination RFT (Request For Termination) for watching has been received. If the judgment result in step S17 is positive, the transmission of the frames FR_CA including the image IMG_TG is finished. Otherwise, the processing of steps S15 and S16 is performed. That is, the processing of steps S15 to S17 is repeatedly executed until the request for termination RFT is received.

### 3. Features of Embodiment

In the tracking of the watching target TG using the feature quantity FTG, the shape image IMG_TGS of the watching target TG is required to extract the feature quantity FTG. However, the appearance (for example clothes) of the watching target TG changes day by day. Further, the appearance changes when the watching target TG changes clothes even in one day, and the appearance changes when the watching target TG takes off the jacket. Therefore, the accuracy of tracking cannot be guaranteed by the shape image IMG_TGS registered in advance.

Therefore, in the embodiment, in order to acquire the latest shape image IMG_TGS of the watching target TG, two infrastructure cameras for capturing a face and a shape are installed in the doorway of the building. Then, face authentication processing is performed using the face image IMG_PSF of the person PS acquired using the infrastructure camera for face imaging and the face image IMG_TGF registered in advance, and the watching target TG is specified. Then, the shape image IMG_PSS of the person PS specified as the watching target TG by the face authentication processing among the shape image IMG_PSS of the person PS acquired using the infrastructure camera for figure photographing is estimated as the shape image IMG_TGS of the watching target TG.

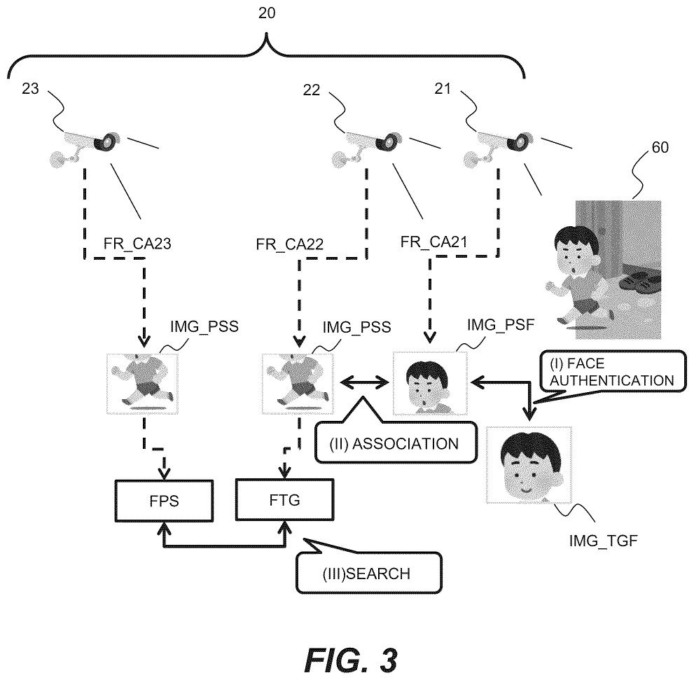

FIG. 3 is a diagram illustrating a feature of watch processing of a watching target TG performed in the embodiment. In FIG. 3, infrastructure cameras 21, 22 and 23 are depicted. These infrastructure cameras are all cameras belonging to the infrastructure cameras 20. The infrastructure camera 21 is an example of the “first infrastructure camera” of the present disclosure, the infrastructure camera 22 is an example of the “second infrastructure camera” of the present disclosure, and the infrastructure camera 23 is an example of the “third infrastructure camera” of the present disclosure.

The infrastructure cameras 21 and 22 are separately installed in a doorway 60 of a building (for example, a residential house, a public facility such as a school or a hospital, or a commercial facility such as a store or an office). The infrastructure cameras 21 and 22 are installed as a set of two cameras. The total number of sets of the infrastructure cameras 21 and 22 is one or more.

The infrastructure camera 21 is a camera for capturing a face, whereas the infrastructure camera 22 is a camera for capturing a shape. For example, the infrastructure camera 21 is installed at a position and a height at which the vicinity of the face of a person passing through the doorway 60 can be captured. The focal length of the infrastructure camera 21 may be adjusted such that the vicinity of the face of the person passing through the doorway 60 is captured by zoom imaging. The infrastructure camera 22 is installed at a position and height at which the entire appearance of a person passing through the doorway 60 can be captured. A wide-angle lens or a fisheye lens that captures the entire appearance of the person passing through the doorway 60 may be used as the infrastructure camera 22.

The infrastructure camera 23 is installed in a place other than the doorway 60. Examples of the place other than the doorway 60 include indoor construction of the building in which the infrastructure cameras 21 and 22 are installed (for example, an inner wall such as a wall surface of a path or a wall surface of a room) and outdoor construction of the building (for example, an outer wall of construction around the building). The total number of the infrastructure camera 23 installed at the same location is one or more. The configuration of the infrastructure camera 23 is the same as that of the infrastructure camera 22. That is, the infrastructure camera 23 is a camera for capturing a shape.

The watch processing includes (I) face authentication processing, (II) association processing, and (III) search processing. (I) In the face authentication processing, the face image IMG_PSF extracted from the frames FR_CA from the infrastructure camera 21 is collated with the face image IMG_TGF of the watching target TG that is registered in advance. Then, when a collation result that these face image s match is obtained, the face image IMG_PSF is identified as the face image of the watching target TG.

In the association processing (II), the shape image IMG_PSS extracted from the frames FR_CA22 of the infrastructure camera 22 and the face image IMG_PSF extracted from the frames FR_CA21 of the infrastructure camera 21 are associated with each other. Since the installation positions and the angles of view of the infrastructure cameras 21 and 22 are known, the person PS whose shape image IMG_PSS is located on the coordinates (x, y) of the frame acquired by the infrastructure camera 22 at the time when the infrastructure camera 21 acquires the face image IMG_PSF can be specified. When a plurality of face images IMG_PSF are acquired on the coordinates (x, y) at the same time, the shape image IMG_PSS to be associated with the face image IMG_PSF may be specified based on the positional relationship between the infrastructure cameras 21 and 22.

In the association processing (II), frames FR_CA22 including the shape image IMG_PSS associated with the face image IMG_PSF and frames FR_CA21 including the face image IMG_PSF are recorded in combination with information of a time stamp, information of position coordinates on the frame of the face image IMG_PSF, and information of position coordinates on the frame of the shape image IMG_PSS. In the association processing (II), information of the feature quantity FPS extracted from the shape image IMG_PSS may be further combined.

The face authentication processing (I) and the association processing (II) are performed, and thus it is possible to specify a shape image IMG_PSS associated with the face image IMG_TGF of the watching target TG among the shape image IMG_PSS. The identified shape image IMG_PSS may be estimated as the latest shape image IMG_TGS of the watching target TG. In addition, the feature quantity FPS extracted from the specified shape image IMG_PSS may be estimated as the latest feature quantity FTG of the watching target TG.

The search processing (III) is performed when the data processing device 11 illustrated in FIG. 1 receives the request for watching RFW. Even when the request for watching RFW is not received, the search processing (III) may be performed. In the search processing (III), the shape image IMG_PSS is extracted from the frames FR_CA23 of the infrastructure camera 23, and the feature quantity FPS is extracted from the shape image IMG_PSS. In the search processing (III), the shape image IMG_TGS is extracted from the frames FR_CA22 including the shape image IMG_TGS, and the feature quantity FTG is extracted from the full-body image IMG_TSG. When the extraction of the feature quantity FTG is performed in the association processing (II), the extraction of the feature quantity FTG is not performed in the search processing (III).

In the search processing (III), the feature quantity FPS and the feature quantity FTG are compared. Then, when the feature quantity FPS matching the feature quantity FTG is detected, the frames FR_CA including the shape image IMG_PSS having the feature quantity FPS and the infrastructure camera 23 that has acquired the frames FR_CA are specified. The frames FR_CA23 of the infrastructure camera 23 identified in this way are transmitted to the user terminal 30, which is the source of the request for watching RFW, when the data processing device 11 receives the request for watching RFW.

### 4. Watch Processing Distribution

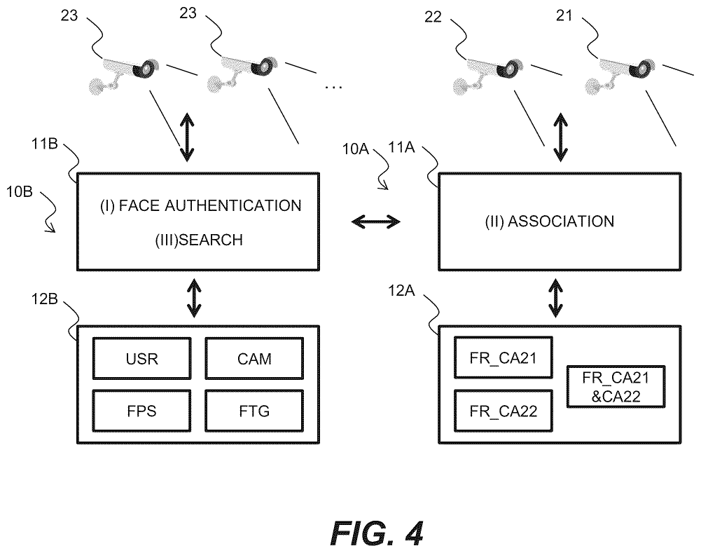

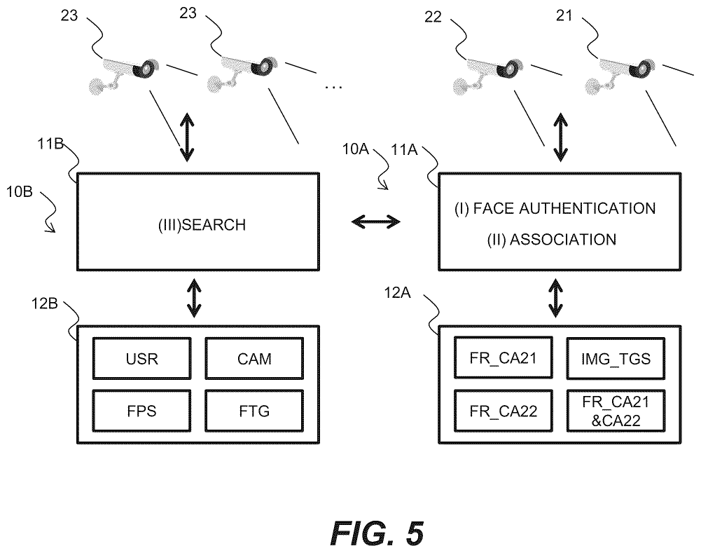

FIGS. 4 and 5 are diagrams for explaining an example of a case where watch processing is shared by two or more data processing devices. In the first example shown in FIG. 4, the management server 10 shown in FIG. 1 is composed of a local server 10A and a remote server 10B. The local server 10A is an example of “1processing circuitry” in the present disclosure, and the remote server 10B is an example of “2processing circuitry” in the present disclosure. The local server 10A is connected to infrastructure cameras 21 and 22. On the other hand, the remote server 10B is connected to the infrastructure camera 23. The local server 10A performs a part of the watch processing. The remote server 10B manages the whole watching service.

The local server 10A includes a data processing device 11A and a database 12A. The configuration example of the data processing device 11A is the same as that of the data processing device 11 described in FIG. 1. The data processing device 11A performs processing related to the association processing (II). That is, the data processing device 11A extracts the face image IMG_PSF from the frames FR_CA21 stored in the database 12A, and also extracts the shape image IMG_PSS from the frames FR_CA22 stored in the database 12A. The data processing device 11A also associates the face image IMG_PSF with the face image IMG_PSF. The frames FR_CA21 and CA22 shown in the database 12A indicates the data set of the frames after the association.

The remote server 10B comprises a data processing device 11B and a database 12B. The configuration example of the data processing device 11B is the same as that of the data processing device 11 described in FIG. 1. The data processing device 11B performs the processing related to the face authentication processing (I) and the processing related to search processing (III). That is, in the processing related to the face authentication processing (I), the frames FR_CA21 and CA22 are received from the local server 10A. Further, the face image IMG_PSF included in the frames FR_CA21 is specified from the frames FR_CA21 and CA22 and the information of the position coordinates on the frame of the face image IMG_PSF. Then, the specified face image IMG_PSF is compared with the face image IMG_TGF included in the user data USR, and the face image IMG_PSF that matches the face image IMG_TGF is specified.

When the face image IMG_PSF that matches the face image IMG_TGF is identified, processing related to the search processing (III) is performed. That is, the data processing device 11B determines whether or not the request for watching RFW is received, and when the judgment result is positive, the search processing (III) is performed. Alternatively, the data processing device 11B performs the search processing (III) without determining whether or not the request for watching RFW is received. In the search processing (III), the face image IMG_PSF is extracted from the frames FR_CA23 included in the camera data CAM, and the feature quantity FPS is extracted from the face image IMG_PSF.

In the search processing (III), the shape image IMG_PSS associated with the face image IMG_PSF matching the face image IMG_TGF is regarded as the shape image IMG_TGS of the watching target TG, and the shape image IMG_PSS regarded as the shape image IMG_TGS is specified based on the frames FR_CA21 and CA22 and the information of the position coordinates on the frame of the shape image IMG_PSS. Then, the feature quantity FTG is extracted from the specified shape image IMG_PSS and compared with the feature quantity FPS extracted from the frames FR_CA23. As a result of the comparison, when the feature quantity FPS matching the feature quantity FTG is detected, the frames FR_CA23 including the shape image IMG_PSS having the feature quantity FPS and the infrastructure camera 23 that has acquired the frames FR_CA23 are specified.

As described above, in the first example, the association processing (II) is performed in the local server 10A. Therefore, the processing load of the remote server 10B can be reduced as compared with the case where the association processing (II) is performed in the remote server 10B. In addition, in the case of separately transmitting the frames FR_CA21 and FR_CA22 to the remote server 10B, if one of the frames cannot be transmitted, there is a possibility that a trouble occurs in the association processing (II) or the search processing (III). In this regard, according to the first example, since the frames FR_CA21 and CA22 are transmitted to the remote server 10B, it is possible to prevent the occurrence of such a problem.

As in the first example, in the second example shown in FIG. 5, the management server 10 shown in FIG. 1 is composed of a local server 10A and a remote server 10B. Unlike the first example, in the second example, the data processing device 11A performs (I) processing related to face authentication processing in addition to the processing related to association processing (II), and the data processing device 11B performs only the processing related to the search processing (III).

When the data processing device 11A performs the processing related to the face authentication processing (I), the face image IMG_TGF of the watching target TG needs to be acquired by the data processing device 11A. Therefore, it is required to store the face image IMG_TGF in the database 12B in advance or to acquire the face image IMG_TGF from the database 12A every time the face authentication processing (I) occurs.

However, in the second example, the shape image IMG_PSS associated with the face image IMG_PSF matching the face image IMG_TGF can be identified in the local server 10A by the face authentication processing (I) and the association processing (II). Therefore, instead of frames FR_CA21 and CA22, it is possible to perform processing of transmitting only frames FR_CA22 including shape image IMG_PSS associated with face image IMG_PSF matching face image IMG_TGF to the remote server 10B. This leads to a reduction in the amount of communication between the local server 10A and the remote server 10B, and thus can be said to be an advantage of the second example.

What is claimed is:

1. A system for managing a watching service that provides a user with an image including a watching target captured by an infrastructure camera, the system comprising:
a first infrastructure camera that is included in the infrastructure camera and is configured to capture a face image of a person passing through a doorway of a building;
a second infrastructure camera that is included in the infrastructure camera and is configured to capture a full-body image of a person passing through the doorway; and
a processing circuitry configured to perform watch processing of the watching target using first frames from the first infrastructure camera and second frames from the second infrastructure camera.

2. The system according to claim 1, further comprising:
a third infrastructure camera included in the infrastructure camera and configured to acquire third frames,
wherein the watch processing comprises:
association processing of a face image of the person extracted from the first frames and a full-body image of the person extracted from the second frames;
face authentication processing to identify a face image of the person that matches the face image of the watching target by using the face image of the person extracted from the first frames; and
search processing to estimate a full-body image associated with a face image matching the face image of the watching target as the full-body image of the watching target by using results of the association processing and the face authentication processing, and to compare the estimated full-body image with the full-body image of the person extracted from the third frames to search for the watching target.

3. The system according to claim 2,
wherein the processing circuitry comprises:
a first processing circuitry connected to the first infrastructure camera and the second infrastructure camera and configured to perform a part of the watch processing; and
a second processing circuitry connected to the first processing circuitry and the third infrastructure camera and configured to manage the entire watching service,
wherein the watch processing performed by the first processing circuitry includes the association processing, and
wherein the watch processing performed by the second processing circuitry includes the face authentication processing and the search processing.

4. The system according to claim 2,
wherein the processing circuitry comprises:
a first processing circuitry connected to the first infrastructure camera and the second infrastructure camera and configured to perform a part of the watch processing; and
a second processing circuitry connected to the first processing circuitry and the third infrastructure camera and configured to manage the entire watching service,
wherein the watch processing performed by the first processing circuitry includes the association processing and the face authentication processing, and
wherein the watch processing performed by the second processing circuitry includes the search processing.

5. A method for managing a watching service that provides a user with an image including a watching target captured by an infrastructure camera, the method comprising:
acquiring first frames from a first camera included in the infrastructure camera and configured to capture a face image of a person passing through a doorway of a building;
acquiring second frames from a second camera included in the infrastructure camera and configured to capture a full-body image of the person passing through the doorway; and
performing watch processing of the watching target using the first frames and the second frames.
